(19) United States
(12) Patent Application Publication
(10) Pub. No.: US 2006/0291525 A1
(43) Pub. Date: Dec. 28, 2006

(54) Electrode joint

(75) Inventors: John Montminy, Hickory, NC (US); Edward G. Morris, Johnson City, TN (US); Alan Price, Hickory, NC (US)

Correspondence Address: LERNER GREENBERG STEMER LLP, P O BOX 2480, HOLLYWOOD, FL, 33022-2480, US

(73) Assignee: SGL Carbon Aktiengesellschaft

(21) Appl. No.: 11/413,724

(22) Filed: Apr. 28, 2006

Related U.S. Application Data
(60) Provisional application No. 60/675,596, filed on Apr. 28, 2005.

(51) Int. Cl. H05B 7/14

(52) U.S. Cl. 373/92

(57) ABSTRACT

An electrode assembly is secured against loosening/unscrewing and cracking of carbon and/or graphite electrodes. The electrodes are connected in columns with threaded connection elements, i.e., carbon nipples. The diameter of the nipples at their equator is 80 to 110% of the diameter of the electrodes. When the electrodes are connected by the nipples, they are not in direct contact with each other. This joint design is a “hybrid” between the widespread conventional nipple joint design and the rarely used male/female joint design. Further, the male/female joint design geometrical design is improved by precluding end-face contact of the electrodes and thus all electrical current must pass through the fully engaged threads of the male and female surfaces and not through the end-faces of the electrodes.

### CROSS-REFERENCE TO RELATED APPLICATION

This application claims the priority, under 35 U.S.C. § 119(e), of provisional application No. 60/675,596, filed Apr. 28, 2005; the prior application is herewith incorporated by reference in its entirety.

### BACKGROUND OF THE INVENTION

### Field of the Invention

The invention relates to carbon or graphite electrode columns with a threaded joint that is combining the advantages of traditional electrode-nipple joints as well as of male/female electrode joints. In particular, the invention relates to carbon or graphite electrode columns comprising nipples having at their equator 80 to 110% the diameter of the connected electrodes.

The technique of manufacturing carbonized or graphitized carbon, also including carbon electrodes and connecting pins therefor, has been known in the art for over a hundred years and it is applied on a large industrial scale. Accordingly, it has been refined in many respects and optimized in terms of costs. One description of this technology may be found in ULLMANN'S ENCYCLOPEDIA OF INDUSTRIAL CHEMISTRY, Vol. A5, VCH Verlagsgesellschaft mbH, Weinheim, 1986, pp. 103-113.

An arc furnace contains at least one column of carbon electrodes. The upper end of such a column is retained by a bracket, through which the electrical current for the electrode column is also supplied. When the furnace is in use, the electric arc passes from the bottom tip or lower end of the column into the metal for melting that is located in the furnace. The electric arc and the high temperatures in the furnace cause the bottom end of the electrode column to burn away slowly. Eventually, as the electrode column is consumed, a new electrode section is added by joining it to the upper end of the upper electrode section of the electrode column. Thus, adequate electrode column length is assured by adding new electrode sections to the top of the electrode column, which protrudes through the furnace roof.

A common method of joining the two electrode sections together is by use of a threaded nipple (connecting pin). The nipple is screwed into correspondingly threaded sockets provided in the end faces of the two electrode sections. The threaded portions may be cylindrical. In most applications a tapered, threaded nipple is used for its superior strength. Such prior art nipples have at their equator 40 to 70% of the diameter of the connected electrodes.

The electrodes are screwed to a column either by hand or with a machine. Particularly in the case of electrodes having a large diameter of 600 mm or more, significant forces and turning moments or screwing effort must be applied in order to ensure that an electrode column will not come apart. Secure attachment of a column is vitally important for the functioning of an arc furnace.

When an arc furnace is in use, considerable flexing moments are exerted repeatedly on the electrode column due to the oscillation of the furnace casing including the column, or the column is subjected to constant vibration; the column is exposed to impacts from the charge material, which also places stresses on the secure attachment of the column. All such stresses—repeated flexing moments, vibrations and impacts—are capable of causing the threaded connection of electrodes to loosen. Loosening must be considered to be the result of unavoidable and/or undesirable processes.

When a screw connection becomes loose, the nipple is usually exposed to a high thermal and mechanical load. Ultimately, mechanical failure of the nipple due to overheating and mechanical loading is to be expected. As a result, the lower end of the electrode column breaks off and falls into the molten steel, the electric arc is interrupted and the smelting process is terminated.

Further, the nipple has to exhibit considerably higher mechanical strength than the electrodes since it has to hold the entire weight of the lower part of the adjacent electrode column. As a consequence, the nipple has material properties different from those of the connected electrodes. For example, the nipple material is denser and has a different CTE (coefficient of thermal expansion).

Along with advancement of high-load operation of arc furnaces, the electrodes and nipples are exposed, in addition to mechanical load, to high electric load. Rupturing of the electrode occurs frequently and mostly in the joint area. It is known, that the temperature of the central portion of an electrode becomes higher in recent direct-current electric arc furnaces than in conventional alternating-current electric arc furnaces. The nipple, which is located in the central portion of an electrode, is therefore exposed to a high temperature, with the result of high thermal stresses that cause ruptures in the joint area especially since the nipple has a CTE different from the electrodes.

The consequences of electrode rupturing while the furnace is in operation are already described above.

In order to counter the problems of inadequate attachment, poor current transfer from one part of the electrode column to the next, and rupturing, a number of very different approaches have been instituted and implemented in the steelworks.

In another electrode joint design, no separate nipple is required. It comprises a machined threaded male surface at one end of the electrode (also referred to as “integrated nipple”) and a threaded female surface at the opposite end of the electrode to receive a corresponding male end from the adjacent electrode. This so-called male/female electrode joint is well documented and has historically been the first electrode joint design. As an example, it has been subject to U.S. Pat. No. 863,674 granted in 1907.

There are several technical advantages of the male/female joint design over a conventional nipple design:
The contact area between the electrodes is maximized and the fully engaged threads and wedging thereof reduce electrical resistance of the joint;
Due to the full engagement of the threads and the wedging effect, there is a resistance to unwinding of the joint;
The physical properties of the nipple are identical to the socket, so material compatibility is not an issue as with conventional joints using a separate smaller nipple; and
As a result, thermal stresses within the joint are minimized, thereby resulting in fewer material losses due to splitting and cracking.

However, there are also disadvantages associated with the male/female design:
Higher assembly torque is required to exploit the lower joint resistance capabilities;
Re-machining of salvaged electrodes following a joint failure is necessary;
Cleaning of the threads before assembly is even more critical than for conventional electrode joints;
Much higher machining losses are associated with each male/female joint, leading to higher costs; and
The effective joint-to-joint distance for a given rough electrode length will be shortened due to geometry considerations—as a result there will be a further increase in machining losses due to the necessity for more joints, and more electrode production capacity would be required to maintain customer requirements.

For those disadvantages, the male/female joint has been substituted in most arc furnace application by the nipple design several decades ago.

### SUMMARY OF THE INVENTION

It is an object of the invention to provide carbon and/or graphite electrode columns which overcome the above-mentioned most critical disadvantages, and yet maintain the most important advantages of the male/female electrode joint design, while overcoming the essential disadvantages of the conventional nipple joint design. It is a specific object of the invention to provide for a “hybrid” design, incorporating both conventional nipple and male/female joint design features.

The assembly according to the invention incorporates the concept of joining a plurality of electrodes, each having a socket on either end, with separate nipples—as in a conventional electrode joint—with several important differences:
There is full thread engagement in both sockets (all nipple thread flanks are in full contact with all socket thread flanks such that there is no inter-flank spacing in a properly tightened joint);
The equator of the connecting pin protrudes beyond the end faces of both connected electrodes, such that facial electrode contact is not possible, thereby allowing full thread engagement in both sockets as described, above;
The major diameter of the nipple is much larger with respect to the electrode diameter than for a conventional joint;
Because there is no facial electrode contact, all of the electrical current is carried through the nipple, as opposed to a conventional nipple-socket design, where most of the electrical current is carried through the electrode end-faces, which must be in tight contact with each other—the area of surface contact is larger for the hybrid design, and therefore the electrical resistance across the joint is lower than for a conventional nipple-socket design; and
The connecting pin material is the same as the electrode material, such that there are virtually no differences in physical properties—as a result there are no connecting pin/socket material compatibility issues.

Such a hybrid joint configuration has the following important advantages:
All of the performance advantages of a typical male/female electrode configuration will be retained;
Electrodes may be salvaged without re-machining of the sockets; broken nipples may be replaced so that they may be reused; and
Longer effective joint-to-joint lengths are possible using the same manufacturing equipment—therefore, the customer will consume fewer electrodes, and electrode manufacturing capacity decreases associated with typical male/female joints will be minimized.

Efficiencies of the hybrid joint may be further improved by optimizing the depth of the sockets, i.e., shallower sockets cause lower material losses, and by using the same raw electrode stock to machine the nipples.

Further performance improvements can be realized by adding a conductive material between the non-contacting electrode endfaces. Preferably this material comprises flexible graphite in the shape of a thick foil or a coil.

Furthermore, it is an also object of this invention to provide an improved male/female joint. The proposed design, incorporates the concept of joining a plurality of electrodes, each having a socket on one end, with an integrated nipple at the other end—as in a conventional male/female electrode joint—with the important difference that the equator of the integrated pin protrudes beyond the end faces of both connected electrodes, such that facial electrode contact is not possible.

Because there is no facial electrode contact, all of the electrical current is carried through the integrated nipple, as opposed to a conventional male/female design, where most of the electrical current is carried through the electrode end-faces, which must be in tight contact with each other—the area of surface contact is larger for the improved male/female joint design, and therefore the electrical resistance across the joint is lower than for a conventional male/female joint design.

With the foregoing and other objects in view there is provided, in accordance with the invention, an assembly with a threaded connection, comprising:

an outer part made from ceramic and having an axial tapered internal thread;

an inner part made from ceramic and having an axial tapered external thread;

the inner part having at its equator 80 to 110% of the diameter of the outer part.

In other words, the threaded connection parts are made from ceramic, preferably from synthetically produced carbon or graphite, and the threads follow a conical shape. When the parts of a threaded connection are engaged, all nipple thread flanks are in full contact with all electrode socket thread flanks such that there is no inter-flank spacing in a properly tightened joint. The equator of the connecting pin protrudes beyond the end-faces of both connected electrodes, such that facial contact is not possible, thereby allowing full thread engagement in both sockets as described, and ensuring that all electrical current is carried through the connecting pin rather than through a combination of the electrode end-faces and connecting pin.

With the above and other objects in view there is also provided, in accordance with the invention, an electrode column with the above-summarized assembly and with a plurality of the outer parts formed as carbon electrodes and the inner parts formed as connecting pins screwing the electrodes together in an electrode column, and with the assembly forming load-bearing connection that is not susceptible to unscrewing or cracking.

For the purposes of the invention, the columns of carbon electrodes should not be loosened or separated from one another by the flexing moments, vibrations or impacts prevalent in steelworks operation, that the elements remained locked in contact with one another and that the threaded connection bears the load of the lower part of the column in each case, while the nipples hold the electrodes together. Further, the columns of carbon electrodes are not prone to cracking caused by thermal stress because the both, electrodes and nipples, are made from the same material.

It is also provided, in accordance with the invention, an assembly with a threaded (male/female) connection, comprising carbon electrodes having a machined threaded male surface at one end and a threaded female surface at the opposite end to receive a corresponding male end from the adjacent electrode, where geometrical design parameters preclude end-face contact of the electrodes and the threads of the male and female surfaces are fully engaged and all electrical current must pass through them and not through the end-faces of the electrodes.

In accordance with an added feature of the invention, the inner part and the outer part are made from synthetically produced carbon or graphite.

In accordance with an additional feature of the invention, the outer part is a carbon electrode with a socket and the internal thread formed therein, and the inner part is a carbon nipple with the external thread formed to mesh with the internal thread for connecting two the electrodes.

In accordance with another feature of the invention, the internal and external threads enclose a taper angle E with a centerline of the inner and outer parts, respectively, of 18 to 35 degrees.

In accordance with a preferred embodiment of the invention, the internal and external threads have a lead D of 2 to 4 threads per inch, and a ratio between an axial length C of the inner part and the diameter B is from 0.5 to 2.0.

In accordance with a further feature of the invention, the assembly configured and dimensioned to preclude end-face contact between the outer parts, wherein the interal threads and the external threads are fully engaged and conduct electrical current flowing between the outer parts to pass through the inner part but not through the end faces of the outer parts.

The following definitions are used herein:

The ends of an electrode are also referred to as the end-faces.

A socket is a coaxial conical depression in the end face of an electrode. (Socket with internal thread=threaded socket).

A nipple is a bi-conical screw having an external thread and one end face arranged perpendicularly to the axis of the nipple on either side thereof. A nipple is screwed about halfway into each socket of adjacent electrodes in order to connect the two electrodes.

An electrode or carbon electrode has a threaded socket on at least one end face. In this document, the connection of two electrodes by means of a separate or an integrated nipple always means a threaded electrode connection. For the sake of simplicity, however, the term electrode joint is used, in the claims also.

Although the invention is illustrated and described herein as embodied in a threaded connection for carbon and/or graphite electrode columns, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 (Prior Art) is a section taken parallel to the longitudinal axes through electrodes 1 and 2 with a machined threaded male surface (not shown) at one end of the electrode 1 and a threaded female (socket) surface 3 at the opposite end of the electrode 1 to receive a corresponding threaded male end (integrated nipple) surface 4 from the adjacent electrode 2.

FIG. 2 is a section taken parallel to the longitudinal axes through electrodes 1 and 2, both having opposing threaded female (socket) surfaces 3 with a bi-conical nipple 5 having two threaded male end surfaces 4 screwed into the socket of both electrodes 1 and 2.

FIG. 3 is a section taken parallel to the longitudinal axes through electrodes 1 and 2, both having opposing threaded female (socket) surfaces 3 with a bi-conical nipple 5 having two threaded male end surfaces 4 screwed into the sockets of both electrodes 1 and 2, describing in more detail essential design features of this invention.

FIG. 4 is a section taken parallel to the longitudinal axes through electrodes 1 and 2 with a machined threaded male surface (not shown) at one end of the electrode 1 and a threaded female (socket) surface 3 at the opposite end of the electrode 1 to receive a corresponding threaded male end (integrated nipple) surface 4 from the adjacent electrode 2.

### DESCRIPTION OF THE PREFERRED EMBODIMENTS

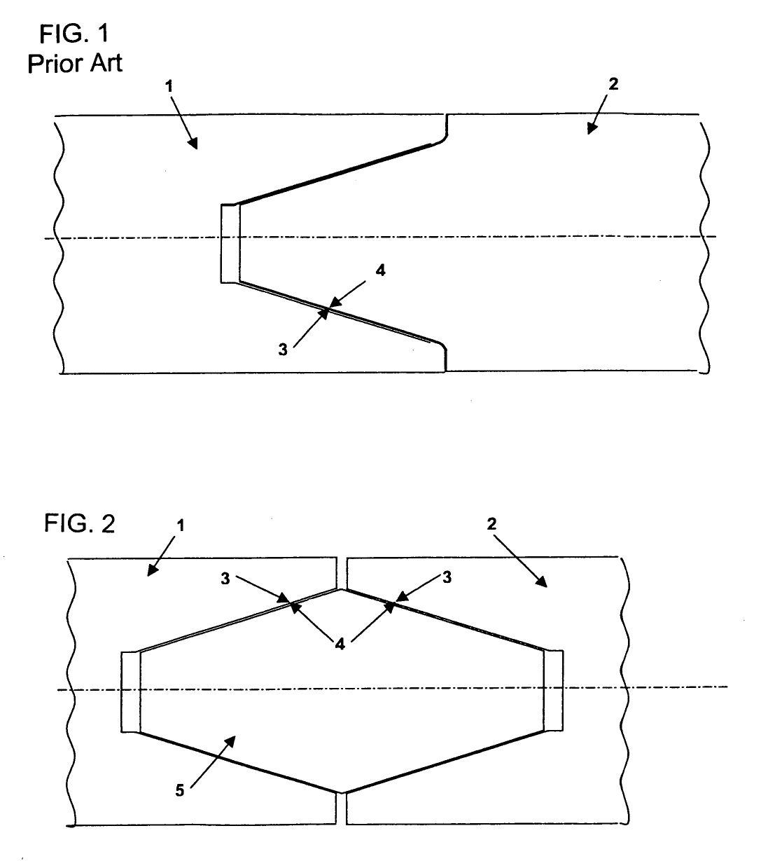

FIG. 1 provides a general view of arrangements of electrodes 1 and 2 according to the prior art male/female joint design. The coaxially arranged socket of electrode 1 as well as the male end from the adjacent electrode 2 are furnished with threaded surfaces 3 and 4. Both thread surfaces are fully engaged. The two electrodes 1 and 2 are fully engaged and have facial contact.

In FIG. 2, the hybrid joint design according to this invention is depicted. Both electrodes 1 and 2 have opposing threaded female (socket) surfaces 3 with a bi-conical nipple 5 having two threaded male end surfaces 4 screwed into the socket of both electrodes 1 and 2. The nipple 5 has at its equator a diameter close to that of the connected electrodes 1 and 2. More particularly, the nipple 5 has at its equator a diameter of 80 to 110% of that of the connected electrodes 1 and 2.

Owning to that large nipple 5 diameter, the nipple 5 is made of the same material as the electrodes 1 and 2 because it does not require the increased mechanical strength over the electrodes to keep up with the mechanical stresses and the weight of the electrode column. This allows manufacturing of the nipples 5 from the same feedstock and with much of the same equipment as used for producing electrodes 1 and 2. Further, nipples 5 may be machined from scrapped electrode pieces.

Besides those considerable economic benefits, the utilization of the same material for both, nipple 5 as well as well as electrodes 1 and 2, paves the way to a threaded joint with fully engaged threads because little to no thermal stress in the joint area will occur since there the CTE of nipple 5 and electrodes 1 and 2 is the same.

In turn, this design feature provides a very tight locked connection, hence electrodes are not as easily loosened or separated from one another by mechanical forces as is possible in a conventional connecting pin design. Furthermore, this new design feature provides a much lower electrical and thermal resistance from nipple 5 to electrodes 1 and 2. This effect is a very considerable benefit over the conventional nipple joint design, where the nipple threads are only partially abutting the electrode socket threads and thus the contact between both electrode faces is essential for electrical and thermal conductivity throughout the electrode column. However, due to the extreme thermal load an electrode column is exposed in the arc furnace, the electrodes that would actually elongate in the heat start warping and cracking because free elongation is hindered by their facial contact.

In contrast, thanks to the much lower electrical and thermal resistance from nipple 5 to electrodes 1 and 2 in the joint design of this invention, a facial clearance between electrodes 1 and 2 can be incorporated. Hence, the electrodes 1 and 2 are more able to freely elongate and do not generate additional mechanical stress.

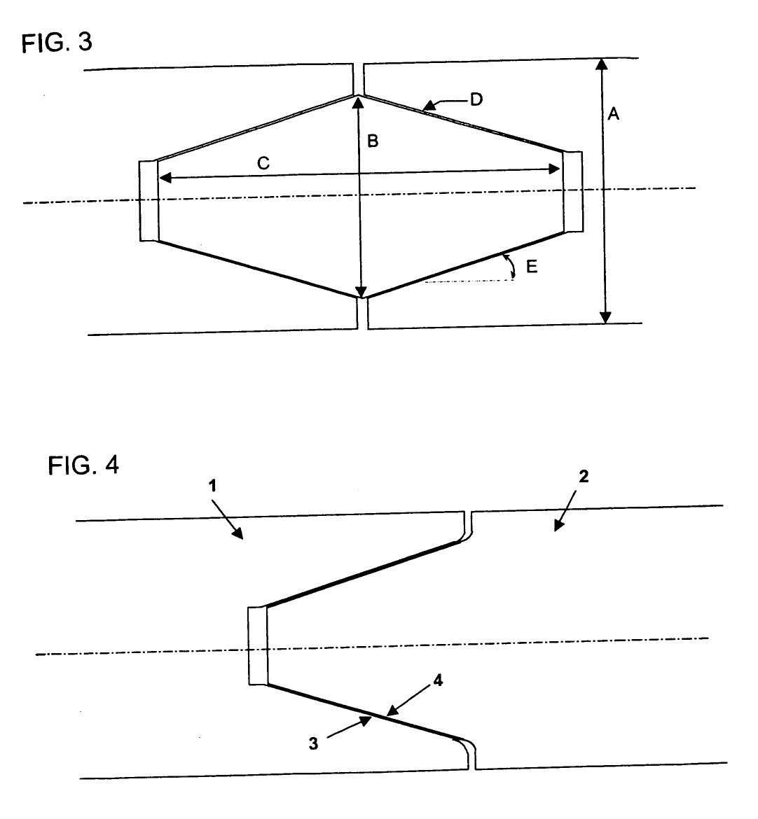

In FIG. 3, several design features of the hybrid joint design according to this invention are depicted in more detail. Both electrodes 1 and 2 have a diameter A. The nipple 5 has at its equator a diameter B of 80 to 110% of the diameter A of the connected electrodes 1 and 2. The nipple length C is defined as the axial face-to-face length of the nipple 5. According to this invention, the ratio of nipple length C to nipple diameter B ranges from 0.5 to 2.0. The thread lead D is measured in threads per inch (TPI). According to this invention, the threads of the threaded female (socket) surfaces 3 and of the two threaded male end surfaces 4 have a thread lead of 2 to 4 threads per inch. The taper angle E of the threaded female (socket) surfaces 3 and of the two threaded male end surfaces 4 from the centerline of the electrode column can range from approximately 18 to 35 degrees.

FIG. 4 provides a general view of arrangements of electrodes 1 and 2 of a male/female joint design according to this invention. The coaxially arranged socket of electrode 1 as well as the male end (integrated nipple) from the adjacent electrode 2 are furnished with threaded surfaces 3 and 4. Both thread surfaces are fully engaged. The two electrodes 1 and 2 are fully engaged but have no facial contact as the equator of the integrated pin protrudes beyond the end faces of both connected electrodes. As a result, all electrical current must pass through the integrated nipple and not through the end-faces of the electrodes.

We claim:

1. An assembly with a threaded connection, comprising:
an outer part made from ceramic, having an axially tapered internal thread, and having a diameter A;
an inner part made from ceramic, having an axially tapered external thread, and having an equator with a diameter B, and;
said diameter B at said equator of said inner part amounting to between 80% and 110% of said diameter A of said outer part.

2. The assembly according to claim 1, wherein said inner part and said outer part are made from synthetically produced carbon or graphite.

3. The assembly according to claim 1, wherein said outer part is a carbon electrode with a socket and said internal thread formed therein, and said inner part is a carbon nipple with said external thread formed to mesh with said internal thread for connecting two said electrodes.

4. The assembly according to claim 1, wherein said internal and external threads enclose a taper angle E with a centerline of said inner and outer parts, respectively, of 18 to 35 degrees.

5. The assembly according to claim 1, wherein said internal and external threads have a lead D of 2 to 4 threads per inch.

6. The assembly according to claim 1, wherein said inner part has an axial length C, and a ratio of said axial length C to said diameter B is from 0.5 to 2.0.

7. The assembly according to claim 1, wherein said outer parts and said inner part a configured and dimensioned to preclude end-face contact between said outer parts, wherein said interal threads and said external threads are fully engaged and conduct electrical current flowing between said outer parts to pass through said inner part but not through the end faces of said outer parts.

8. An electrode column, comprising:
the assembly according to claim 1, wherein said plurality of outer parts are carbon electrodes and said inner part is a nipple screwing said carbon electrodes together to form the electrode column, and wherein the assembly forms a load-bearing connection that is substantially not susceptible to unscrewing and cracking.

9. An assembly with a threaded connection, comprising:
carbon electrodes having a machined threaded male surface at one end thereof and a threaded female surface at an opposite end thereof configured to receive a corresponding male end from an adjoining electrode;
wherein said male and female surfaces are configured with geometrical design parameters that preclude end-face contact between mutually adjoining electrodes, and said threads of said male and female surfaces are fully engaged to force all electrical current to pass therethrough and not through end faces of said electrodes.
